(19) United States
(12) Patent Application Publication
(10) Pub. No.: US 2003/0047365 A1
(43) Pub. Date: Mar. 13, 2003

(54) Fluid inlet grille with novel aerodynamic grill bars

(76) Inventors: Sunil K. Jain, Fort Wayne, IN (US); Scott A. Wooldridge, Fort Wayne, IN (US); Timothy P. Nobel, Fort Wayne, IN (US); David J. Beigel, Kettering, OH (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/213,180

(22) Filed: Aug. 6, 2002

Related U.S. Application Data
(60) Provisional application No. 60/310,921, filed on Aug. 8, 2001.

(51) Int. Cl. B60K 11/00

(52) U.S. Cl. 180/68.1

(57) ABSTRACT

A novel fluid inlet grille with novel aerodynamic grille bars is disclosed. Each of the novel-aerodynamic grille bars of the fluid inlet grille is constructed in such a manner that along a majority of its length its cross-section perpendicular to its longitudinal axis has a chord length that is greater than twice its maximum width, a maximum width that is greater than its trailing edge width, and is disposed such that its chord line is disposed at an angle of less than ten degrees to a prevailing direction of inflowing air.

This is a non-provisional application claiming priority under provisional patent application serial No. 60/310,921 filed Aug. 8, 2001.

### BACKGROUND OF THE INVENTION

This invention relates to fluid inlet grilles that are constructed to span a fluid flow inlet and allow fluid to flow through the fluid flow inlet while preventing large objects from passing through the fluid flow inlet. Such fluid inlet grilles have a plurality of grille bars, each of which extends across a portion of the fluid flow inlet that the fluid inlet grille spans. A plurality of fluid flow spaces, through which fluid may flow, are defined between the grille bars of such fluid inlet grilles within the fluid flow inlet spanned by the fluid inlet grille. Objects larger than the fluid flow spaces defined between the grille bars of the fluid inlet grille are prevented from traveling through the fluid flow inlet. The use of such fluid inlet grilles is well known in many different applications. One application where such fluid inlet grilles are used, for example, is in vehicles. Many vehicles have a fluid flow inlet that is defined between body panels of the vehicle and that is disposed in front of one or more heat exchangers such as radiators, air conditioner condensers, charge air coolers, and/or transmission coolers. A fluid inlet grille mounted to a vehicle in such a manner allows the flow of fluid, which is usually air, through the fluid flow spaces between the grille bars and then through the heat exchangers disposed behind the fluid inlet grille. The grille bars of a fluid inlet grille mounted to a vehicle in such a manner also prevent large objects from traveling through the fluid flow inlet and damaging or restricting fluid flow through the heat exchangers disposed behind the fluid flow inlet.

In many applications of such a fluid inlet grille the fluid flow is most always in the same direction through the fluid flow inlet that the fluid inlet grille spans. The mounting of a fluid inlet grille to a vehicle to protect one or more heat exchangers mounted behind the fluid inlet grille, as described above, is one example of an application of a fluid inlet grille where the fluid flow is almost always in the same direction through the fluid inlet which the fluid inlet grille spans. In this application the fluid flow through the fluid flow inlet is almost always in a direction from in front of the fluid inlet grille, through the fluid flow inlet that the fluid inlet grille spans, and then toward and eventually through the one or more heat exchangers mounted behind the fluid inlet grille. For purposes of this disclosure the direction that fluid almost always flows toward and through a fluid flow inlet that a fluid inlet grille spans will be referred to as the prevailing fluid inflow direction. A fluid inlet grille that is used in such an application, in which there exists a prevailing fluid inflow direction, and its grille bars have opposite sides that may be considered an upstream side and a downstream side respectively. The upstream side of such a fluid inlet grille and its grille bars being the side that fluid first passes as it flows in the prevailing fluid inflow direction toward and through the fluid flow inlet which the fluid inlet grille spans. The downstream side of the fluid inlet grille and its grille bars being the side that fluid last passes as it flows in the prevailing fluid inflow direction through and away from the fluid flow inlet.

In many applications in which a fluid inlet grille is used the aerodynamic properties of the fluid inlet grille are important. It is generally desirable that the fluid inlet grille provide as little resistance to flow of the fluid through the fluid flow inlet as possible. It is also preferred that the fluid inlet grille is constructed in such a manner that the velocity distribution of the fluid flow evens out in as short a distance as possible from the downstream side of the fluid inlet grille. A vehicle that has a fluid inlet grille mounted in front of one or more heat exchangers, as described above, is an example of an application in which a fluid inlet grille is used and in which it is desirable that the fluid inlet grille have such aerodynamic properties. In such an application, all other factors being equal, reducing the resistance of the fluid inlet grille to the flow of fluid past it will result in increased velocity of the fluid flow after it has passed the fluid inlet grille and also as it passes through the heat exchangers mounted on the downstream side of the fluid inlet grille. Increased velocity of the fluid flow through the heat exchangers increases the rate of heat transfer and, thus, improves the performance of the heat exchangers. The uniformity of the velocity distribution of the fluid flow as it passes through the heat exchangers in such an application also affects the performance of the heat exchangers. The more uniform the velocity of the fluid flow through the heat exchangers is in directions perpendicular to the direction in which it is flowing, the better the performance of the heat exchangers will be. When fluid flows through a fluid flow inlet past a fluid inlet grille, there is a stagnation area adjacent the downstream side of each of the grille bars. The velocity of the fluid flow in the stagnation area downstream of each of the grille bars is substantially less than the velocity of the fluid flow to either side of the stagnation area in directions perpendicular to the flow of the fluid through the fluid inlet opening. The stagnation area behind each of the grille bars does, however, have a finite length and at some distance in the downstream direction from each grille bar the velocity of the fluid flow is equal to the velocity of adjacent portions of the fluid flow. If a heat exchanger is mounted upon the downstream side of a fluid inlet grille at a distance close enough to the fluid inlet grille that the stagnation area of one or more of the grille bars extends into the heat exchanger the performance of the heat exchanger will be compromised. In such a situation, the fluid flow through those portions of the heat exchanger into which any stagnation areas of the grille bars extend will have a significantly lower velocity than the fluid flow through adjacent portions of the heat exchanger. In such a situation, less heat will be transferred between those portions of the heat exchanger that are disposed within a stagnation area downstream of a grille bar and the fluid flowing through them than will be transferred between adjacent portions of the heat exchanger and the fluid flowing through them. Thus, the overall performance of the heat exchanger is compromised when it is placed close enough to the fluid inlet grille that one or more portions of the heat exchanger are disposed within stagnation area(s) of the grille bars. As a result, many vehicles that have one or more heat exchangers mounted behind a fluid flow inlet, across which a fluid inlet grille spans, have the heat exchangers mounted sufficiently far enough away from the fluid inlet grille to be beyond the stagnation area of each of the grille bars of the fluid inlet grille. In many circumstances, however, space for mounting of components is at a premium on a vehicle and the need to place a heat exchanger at such a distance from a fluid inlet grille on its downstream side can increase the challenges of constructing a vehicle in a compact manner while providing all desirable features.

### SUMMARY OF INVENTION

As a result, an object of the present invention is to provide a fluid inlet grille that presents a relatively low resistance to the flow of fluid past it. Another object of the present invention is to provide a fluid inlet grille that comprises grille bars that have a relatively short stagnation area adjacent their downstream side when fluid is flowing past them.

The fluid inlet grille of the present invention comprises a plurality of novel aerodynamic grille bars that are constructed and oriented in such a manner that their longitudinal axes extend substantially perpendicular to the direction in which fluid flows past the fluid inlet grille. Cross-sections of these aerodynamic grille bars perpendicular to their longitudinal axes, which will hereinafter be referred to as transverse cross-sections, have a chord length, which is the distance between the portion of the novel aerodynamic grille bar at its upstream side and the portion of the novel aerodynamic grille bar at its downstream side. For purposes of this disclosure a line that extends between a midpoint of the portion of a transverse cross-section of the novel aerodynamic grille bar at its upstream side and the midpoint of the portion of the transverse cross-section of the aerodynamic grille at its downstream side is considered to be a chord line of the transverse cross-section. The width of a particular portion of each grille bar is the distance between outer portions of the grille bar in directions perpendicular to both the longitudinal axis and a the chord line of that portion of the grille bar. Each transverse cross-section of a grille bar has a leading edge width, a maximum width, and a trailing edge width. The leading edge width of a grille bar is the width of the portion of the grille bar at the upstream side of the grille bar. The maximum width of the grille bar being the width of the widest portion of a particular transverse cross-section of the grille bar. The trailing edge width of the grille bar is the width of the portion of the grille bar at its downstream side. Of course different transverse cross-sections of a given novel aerodynamic grille bar according to the present invention may have different chord lengths, leading edge widths, maximum widths, and trailing edge widths. Each of a plurality of the novel aerodynamic grille bars of the fluid inlet grille of the present invention has, along a majority of its length, transverse cross-sections that have a chord length that is substantially greater than a maximum width and a trailing edge width that is less than the maximum width. Novel aerodynamic grille bars shaped in such a way present relatively little resistance to the flow of fluid past them and have a stagnation area of relatively short length adjacent their downstream side when fluid flows past them. As a result, a fluid inlet grille that is constructed with a plurality of novel aerodynamic grille bars so constructed presents relatively little resistance to the flow of fluid past it. Such a fluid inlet grille also provides for a relatively uniform distribution of velocity of a fluid flow that has passed the fluid inlet grille at a relatively short distance to the downstream side of the fluid inlet grille. Such a fluid inlet grille is particularly useful when mounted within a fluid flow inlet of a vehicle with one or more heat exchangers disposed upon the downstream side of the fluid inlet grille. Such an application of a fluid inlet grille constructed in such a manner allows for location of one or more heat exchangers relatively close to the fluid inlet grille on its downstream side while providing for a fluid flow through the heat exchangers that has a relatively high velocity and also a relatively uniform velocity distribution in directions perpendicular to the fluid flow. Thus, it can be seen that the above-mentioned objects of the present invention as well as others not mentioned have been met.

### DRAWINGS

Other objects and advantages of the invention will become more apparent upon perusal of the detailed description thereof and upon inspection of the drawings in which:

FIG. 1 is sectional view through line I-I of FIG. 3 showing a portion of a vehicle with a fluid inlet grille that comprises novel aerodynamic grille bars according to the present invention.

FIG. 2 is a view of a transverse cross-section of a first embodiment of a novel aerodynamic grille bar according to the present invention with the chord line thereof oriented a relatively small angle to the prevailing fluid inflow direction.

FIG. 3 is a side elevational view of a vehicle that comprises a fluid inlet grille with novel aerodynamic grille bars according to the present invention.

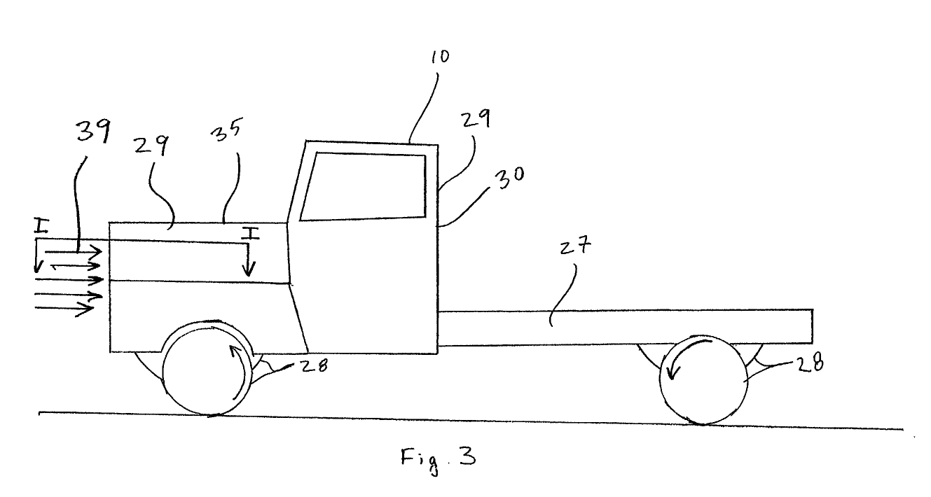

FIG. 4 is a perspective view of a vehicle that comprises a fluid inlet grille with novel aerodynamic grille bars according to the present invention.

FIG. 5 is a sectional view through a front portion of a vehicle that comprises a fluid inlet grille with prior art grille bars.

FIG. 6 is a view of a transverse cross-section of a first embodiment of a prior art grille bar.

FIG. 7 is aview of a transverse cross-section of a second embodiment of a novel aerodynamic grille bar according to the present invention.

FIG. 8 is an enlarged view of the portion of a FIG. 1 disposed within square 8 showing fluid flow patterns through a fluid flow space defined between adjacent novel aerodynamic grille bars of a fluid inlet grille according to the present invention.

FIG. 9 is a view of a transverse cross-section of a third embodiment of a novel aerodynamic grille bar according to the present invention.

FIG. 10 is a view of a transverse cross-section of a fourth embodiment of a novel aerodynamic grille bar according to the present invention.

FIG. 11 is a view of a transverse cross-section of a fifth embodiment of a novel aerodynamic grille bar according to the present invention showing fluid flow patterns around the grille bar as predicted by computational fluid dynamics analysis.

FIG. 12 is a view of a transverse cross-section of a second embodiment of a prior art grille bar showing fluid flow patterns around the grille bar as predicted by computational fluid dynamics analysis.

FIG. 13 is a sectional view of a fluid inlet grille that comprises a plurality of novel aerodynamic grille bars that have a same transverse cross-section as the novel aerodynamic grille bar shown in FIG. 11.

FIG. 14 is a sectional view of a fluid inlet grille that comprises a plurality of prior art grille bars that have the same transverse cross-section as the grille bar shown in FIG. 12.

FIG. 15 is a view of a transverse cross-section of a sixth embodiment of a novel aerodynamic grille bar according to the present invention.

FIG. 16 is a view of a transverse cross-section of a seventh embodiment of a novel aerodynamic grille bar according to the present invention.

FIG. 17 is a view of the transverse cross-section of the embodiment of a novel aerodynamic grille bar shown in FIG. 2 with the chord line of the transverse cross-section oriented at a substantial angle to the prevailing fluid inflow direction.

### DETAILS OF INVENTION

The present invention includes both a fluid inlet grille 12 for mounting within a fluid flow inlet 11 and a vehicle 10 with such a fluid inlet grille 12 mounted to it. The fluid inlet grille 12 comprises a plurality of grille bars 13 that have a substantially fixed position relative to one another and each of which extends across some portion of the fluid flow inlet 11, when the fluid inlet grille 12 is mounted within the fluid flow inlet 11. A plurality of fluid flow spaces 23, through which fluid can flow as it flows through the fluid flow inlet 11, within which the fluid inlet grille 12 is mounted, are defined between adjacent grille bars 13 of the fluid inlet grille 12. Thus, the fluid inlet grille 12 allows the flow of fluid through the fluid flow inlet 11 within which it is mounted, while preventing the passage of objects larger than the fluid flow spaces 23, which are defined between the grille bars 13 of the fluid inlet grille 12, through the fluid flow inlet 11.

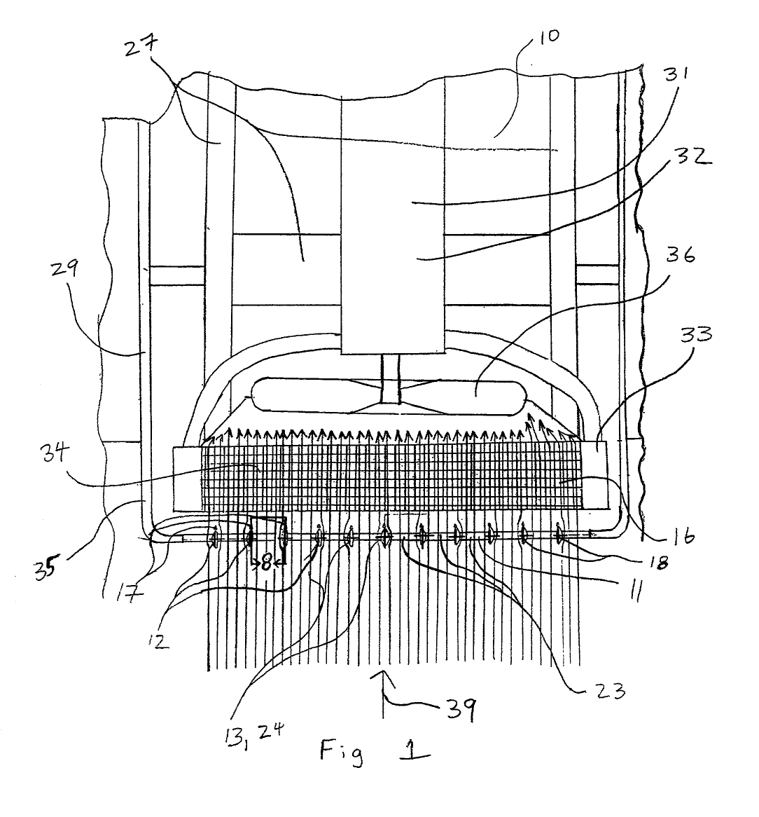

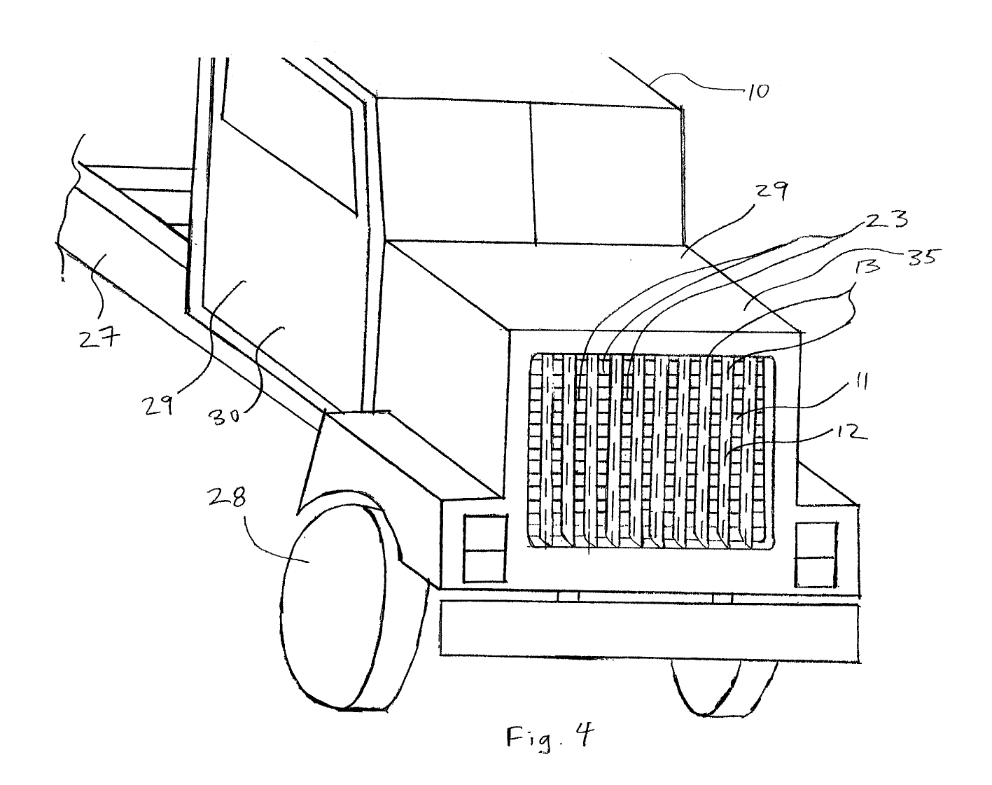

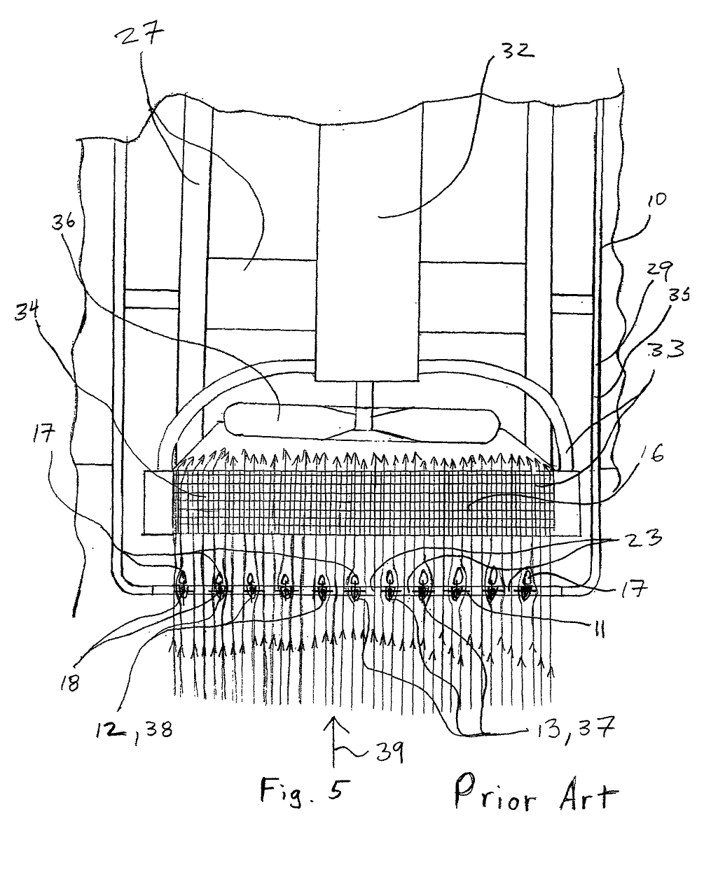

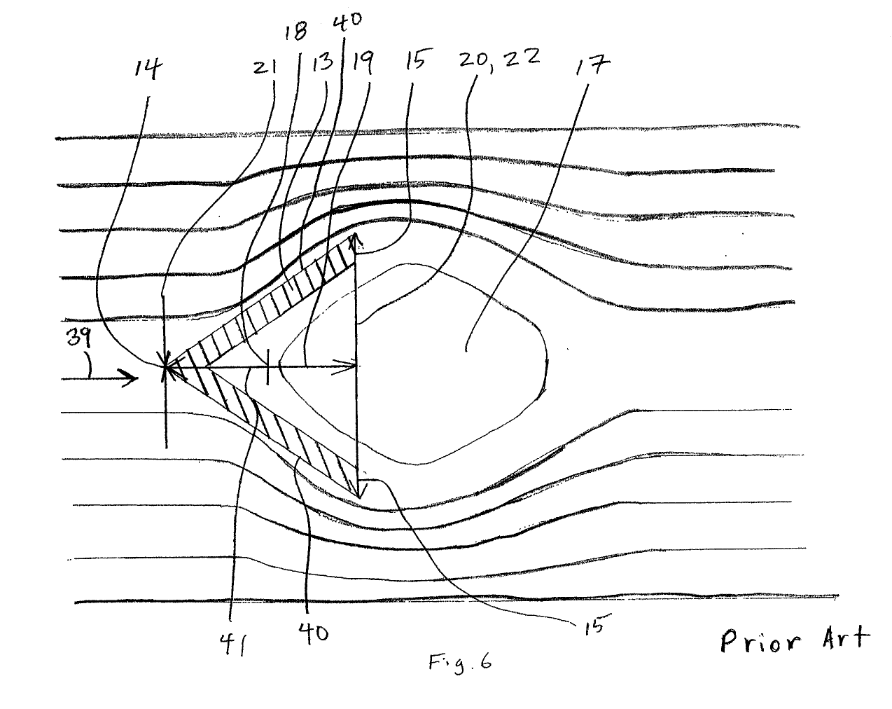

A plurality of the grille bars 13 of the fluid inlet grille 12 of the present invention are novel aerodynamic grille bars 24. The novel aerodynamic grille bars 24 provide for a relatively low resistance of the fluid inlet grille 12 to fluid flow through the fluid flow inlet 11 and also provide for a relatively uniform distribution of fluid flow that has passed the novel aerodynamic grille bars 24, a short distance after it has passed the novel aerodynamic grille bars 24. Each of the novel aerodynamic grill bars 24 of the fluid inlet grill 12 has along a majority of its length, a transverse cross-section that has a chord length 19 that is greater than a maximum width 20 and a maximum width 20 that is greater than a trailing edge width 22. Novel aerodynamic grille bars 24 that have such a shape are shown in FIGS. 1, 2, 4, 7, 8, 11, 13, 15, 16, and 17. As a result of having such a shape, the novel aerodynamic grille bars 24 of the fluid inlet grille 12 of the present invention present relatively little resistance to fluid flow past them as compared to prior art grille bars 37 such as those shown in FIGS. 5, 6, 12, and 14. Additionally, the stagnation area 17 that exists adjacent the downstream side 15 of the novel aerodynamic grille bars 24 when fluid flows past them is considerably shorter than the stagnation area 17 that exists adjacent the downstream side 15 of prior art grille bars 37, such as those shown in FIGS. 5, 6, 12, and 14, when fluid flows past them. The stagnation area 17 that occurs adjacent the downstream side 15 of the novel aerodynamic grille bars 24 is substantially shorter than that which occurs adjacent the downstream side 15 of prior art grille bars 37 such as those shown in FIGS. 5, 6, 12, and 14 because the maximum width 20 of the novel aerodynamic grille bars 24 occurs at a distance from their downstream side 15 whereas the maximum width 20 of the prior art grille bars 37 occurs at their downstream side 15. Because the novel aerodynamic grille bars 24 of the fluid inlet grille 12 narrow as they extend from the point at which their maximum width 20 occurs toward their downstream side 15 the portions of fluid flow disposed upon opposite sides of the novel aerodynamic grille bar 24 can transition toward one another before passing the downstream side 15 of the novel aerodynamic grille bar 24. By comparison, the portions of fluid flow disposed upon opposite sides of prior art grille bars 37 such as those shown in FIGS. 5, 6, 12, and 14 continue to diverge the entire time they flow past the prior art grille bar 37 and cannot begin to transition back toward one another until after they have passed the downstream side 15 of the prior art grille bar 37. As a result, the distance from the downstream side 15 of a respective grille bar 13 at which fluid that flows past opposite sides of the grille bar 13 can converge is shorter for a novel aerodynamic grille bar 24 according to the present invention than it is for a prior art grille bar 13 such as those shown in FIGS. 5, 6, 12, and 14.

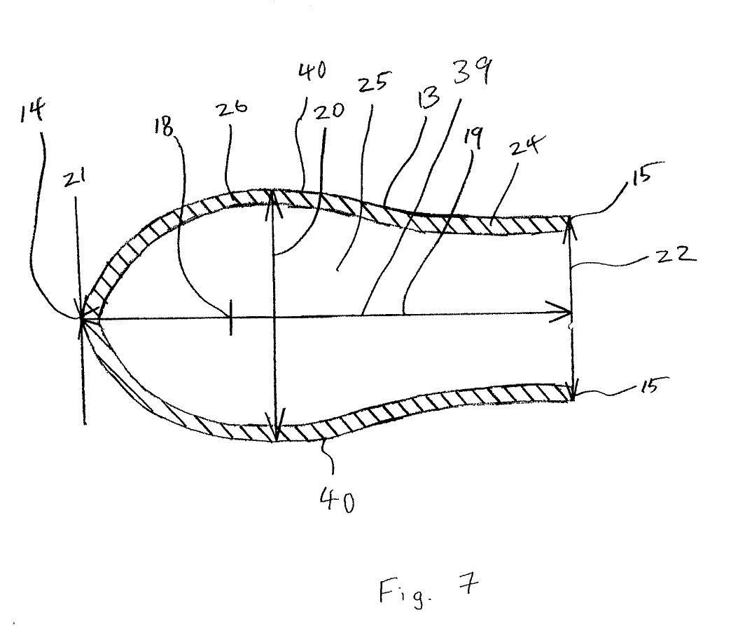

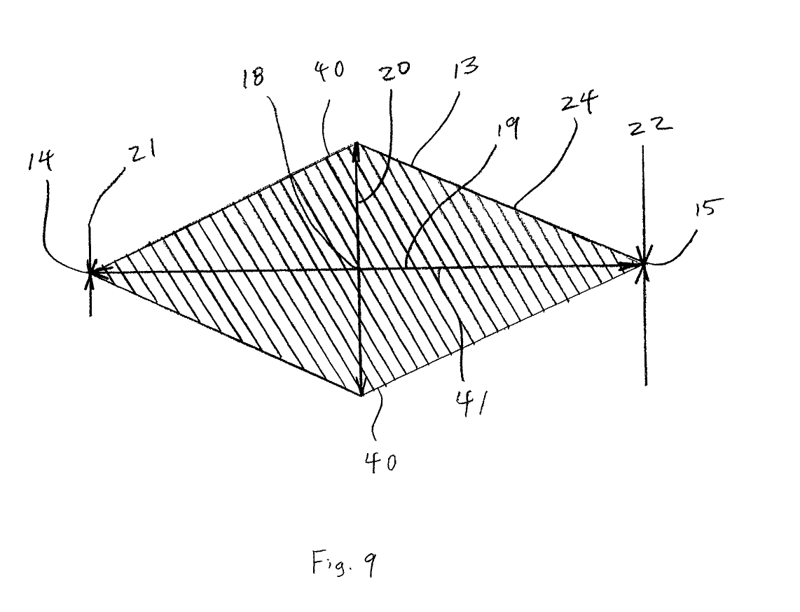

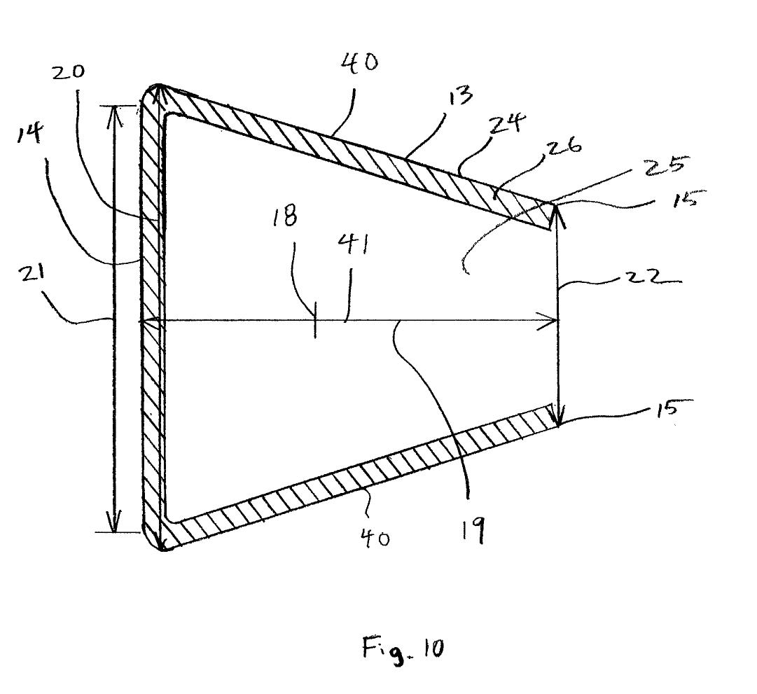

Each of the novel aerodynamic grille bars 24 of the fluid inlet grille 12 may have any of a number of shapes in accordance with the guidelines outlined above. The transverse cross-sections of a novel aerodynamic grille bar 24 may have an outer perimeter that has smooth transitions as it extends around the longitudinal axis 18 as is the case with the novel aerodynamic grille bars 24 shown in FIGS. 1, 2, 7, 8, 10, 11, 13, 15, and 17. Alternatively, the transverse cross-sections of a novel aerodynamic grille bar 24 may have an outer perimeter that includes sharp corners, as is the case with the novel aerodynamic grille bar 24 represented in FIG. 9. Additionally, a novel aerodynamic grille bar 24 may be constructed with an outer wall 26 that at least partially surrounds an interior void 25 of the novel aerodynamic grille bar 24 as is the case with the novel aerodynamic grille bars 24 shown in FIGS. 1, 2, 7, 8, 10, 11, 13, 15, 16, and 17 or a novel aerodynamic grille bar 24 may be of solid construction with no interior void 25 as is the case with the novel aerodynamic grille bar 24 shown in FIG. 9. Construction of a novel aerodynamic grille bar 24 with an outer wall 26 that surrounds an interior void 25 provides a novel aerodynamic grille bar 24 that uses less material than a novel aerodynamic grille bar 24 of similar strength and solid construction and, therefore, allows for lighter weight of and less material costs for the novel aerodynamic grille bars 24. Novel aerodynamic grille bars 24 that have an outer wall 26, inside of which an interior void 25 is defined, may be constructed in such a manner that the outer wall 26 completely surrounds the interior void 25. Novel aerodynamic grille bars 24 that are constructed in such a manner are shown in FIGS. 1, 2, 8, 15, 16, and 17. Alternatively, novel aerodynamic grille bars 24 that have an outer wall 26, within which an interior void 25 is defined, may be constructed in such a manner that the outer wall 26 does not completely surround the interior void 25 and, thus, the interior void 25 opens into the area surrounding the novel aerodynamic grille bar 24. Novel aerodynamic grille bars 24 constructed in such a manner are shown in FIGS. 7 and 10. In the preferred embodiment each of the novel aerodynamic grille bars 24 has an outer wall 26 that completely surrounds an interior void 25 of the novel aerodynamic grille bar 24. In many cases, novel aerodynamic grille bars 24 that have an outer wall 26 that completely surrounds an interior void 25 of the novel aerodynamic grille bar 24 have better aerodynamic properties than novel aerodynamic grille bars 24 that have an outer wall 26 that only partially surrounds an interior void 25 of the novel aerodynamic grille bar 24. It will, of course, be understood that the fluid inlet grille 12 of the present invention may comprise both novel aerodynamic grille bars 24 constructed according to the guidelines set forth in this disclosure and prior art grille bars 37 that are not constructed according to the guidelines set forth in this disclosure for the construction of novel aerodynamic grille bars 24 in accordance with the present invention. It will also be understood that the plurality of novel aerodynamic grille bars 24 of a fluid inlet grille 12 according to the present invention may include novel aerodynamic grille bars 24 that have constructions that are different from one another yet within the guidelines of construction of novel aerodynamic grille bars according to the present invention set forth in this disclosure.

As was mentioned above, the construction of a novel aerodynamic grille bar 24 with its maximum width 20 disposed at a distance from the downstream side 15 of the novel aerodynamic grille bar 24 results in a relatively short stagnation area 17 adjacent its downstream side 15 as compared to a prior art grille bar 37 that has its maximum width 20 at its downstream side 15. In fact, all other factors equal, the smaller the trailing edge width 22 of a grille bar 13 is, the shorter the stagnation area 17 adjacent its downstream side 15 will be when fluid flows past it. For this reason, the preferred embodiment of a novel aerodynamic grille bar 24 according to the present invention has, along a majority of its length, a transverse cross-section that comes to a point at the downstream side 15 of the novel aerodynamic grille bar 24. A transverse cross-section of a novel aerodynamic grille bar 24 that comes to a point at the downstream side 15 of the novel aerodynamic grille bar 24, in such a manner, is considered to have a trailing edge width 22 of zero. The transverse cross-sections of novel aerodynamic grille bars 24 shown in FIGS. 1, 2, 8, 9, 11, 13, 15, 16, and 17 come to a point at the downstream side 15 of the novel aerodynamic grille bar 24 in such a manner and, therefore, are considered to have a trailing edge width 22 of zero.

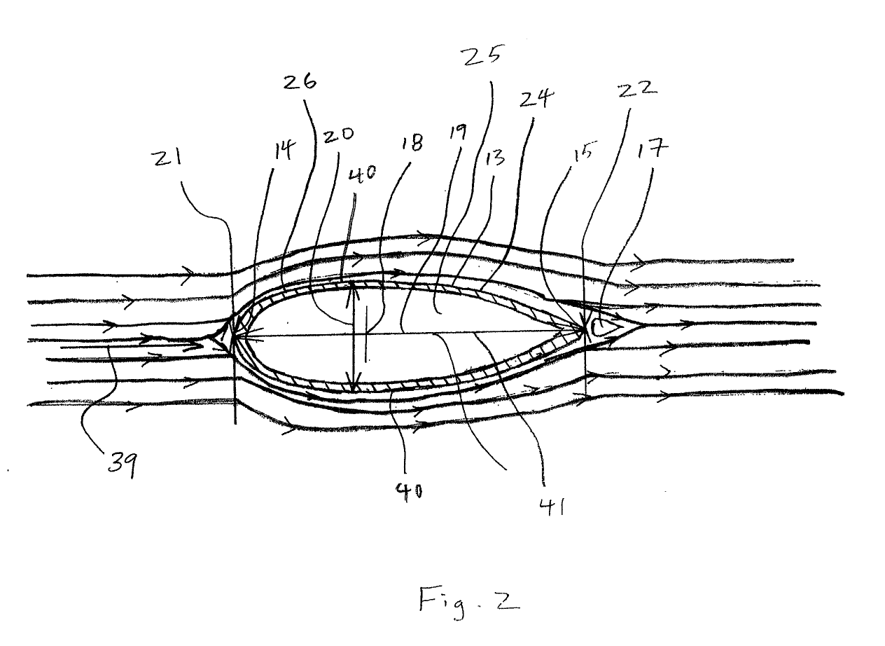

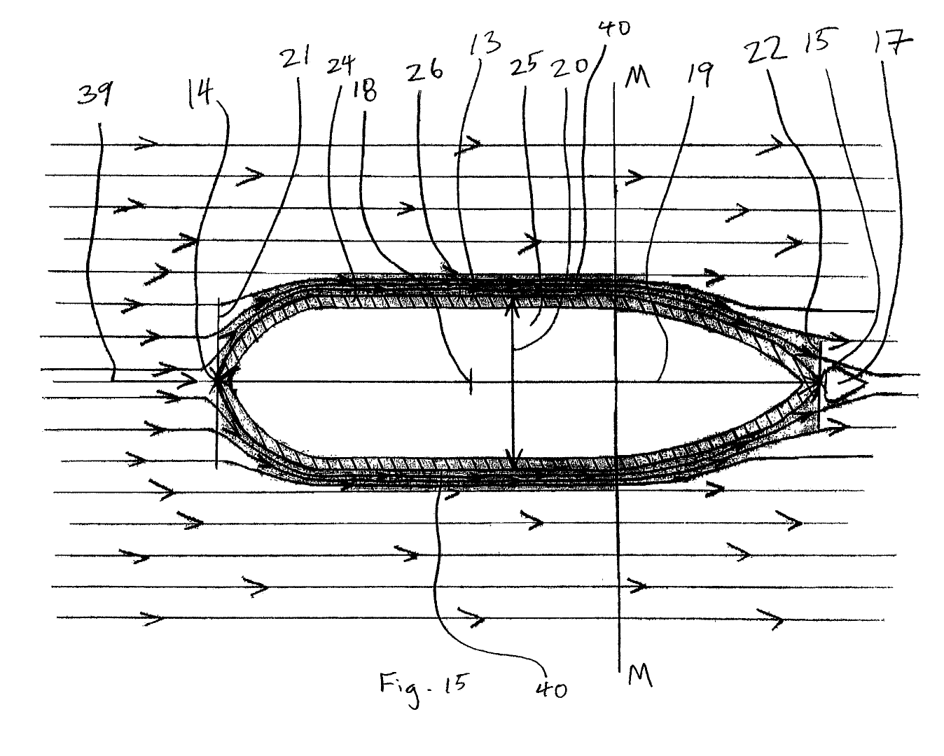

The relative location, within a transverse cross-section of a novel aerodynamic grille bar 24, of the portion of a transverse cross-section of the novel aerodynamic grille bar 24 that defines the maximum width 20 of that transverse cross-section affects the aerodynamic properties of the novel aerodynamic grille bar 24. The further the portion of a transverse cross-section of a novel aerodynamic grille bar 24 that defines the maximum width 20 of that cross-section is from the downstream side 15 of that transverse cross-section, the more time and space fluid flows past opposite sides of the novel aerodynamic grille bar 24 have to converge toward one another after passing the portion of the transverse cross-section that defines the maximum width 20 thereof. Thus, the further the portion of a transverse cross-section of a novel aerodynamic grille bar 24 that defines the maximum width 20 of that transverse cross-section is from the downstream side 15 of that transverse cross-section, the shorter will be the stagnation area 17 adjacent the downstream side 15 of that transverse cross-section of the novel aerodynamic grille bar 24 when fluid flows past it. Thus, for a given transverse cross-section of a novel aerodynamic grille bar 24 the proportion of the chord length 19 of the transverse cross-section to the distance between the downstream side 15 and the portion that defines the maximum width 20 of the transverse cross-section is a parameter that has a considerable effect upon the aerodynamic properties of the transverse cross-section. FIG. 15 illustrates a transverse cross-section of a novel aerodynamic grille bar 24 that has a chord length 19 with a magnitude approximately three times the magnitude of the distance between the downstream side 15 and the portion that defines the maximum width thereof. FIGS. 2, 7, 8, 9, 10, 11, 16, and 17 illustrate transverse cross-sections of novel aerodynamic grille bars 24 that have chord lengths 19 with magnitudes that are greater than three times the magnitude of the distance between their downstream side 15 and the portions thereof that define the maximum width 20 of the transverse cross-section. It should be understood that, while the foregoing discussion focuses upon a proportion of three to one of the chord-length 19 to the distance between the downstream side 15 and the portion of a transverse cross-section of a novel aerodynamic grille bar 24 that defines the maximum width 20 thereof, in general the smaller the proportion of the chord length 19 to the distance between the downstream side 15 and the portion of a transverse cross-section that defines the maximum width 20 thereof the better will be the aerodynamic properties of that transverse cross-section of the novel aerodynamic grille bar 24. Additionally, it will be understood that some embodiments of novel aerodynamic grille bars 24 according to the present invention will have transverse cross-sections that have a portion thereof that has a constant width which is the maximum width 20 of the transverse cross-section. Such a transverse cross-section of a novel aerodynamic grille bar 24 is illustrated in FIG. 15. In the case of such transverse cross-sections of a novel aerodynamic grille bar 24 that have a portion that has a constant width that is the maximum width 20 of the transverse cross-section, the distance between the downstream side 15 and the portion of the transverse cross-section that defines the maximum width 20, which distance is referenced above, is considered to be the distance between the midpoint of the portion of the transverse cross-section at the downstream side 15 and the portion nearest thereto that defines the maximum width 20 of the transverse cross-section. For example, in the case of the transverse cross-section of a novel aerodynamic grille bar 24 illustrated in FIG. 15, the distance between the downstream side 15 of the cross-section and the portion thereof that defines the maximum width 20 is considered to be the distance between the midpoint of the portion of the transverse cross-section at the downstream side 15 and line M-M which extends through the portion of the transverse cross-section that is the portion of the portion that defines the maximum width 20 that is nearest to the downstream side 15.

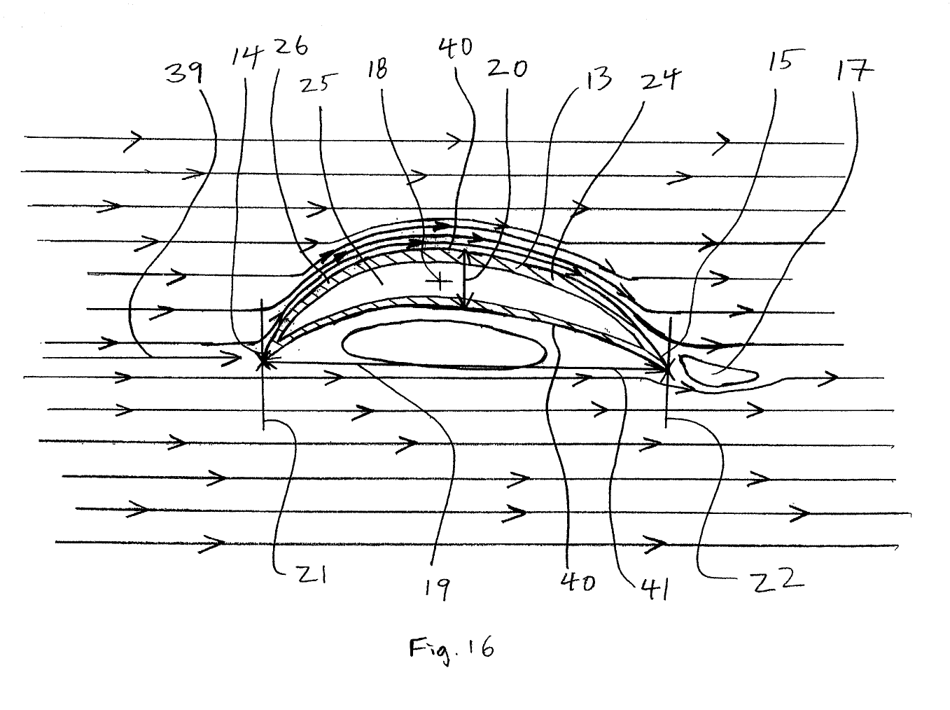

In addition to the relative sizes of various portions of transverse cross-sections of a novel aerodynamic grille bar 24 perpendicular to its longitudinal axis 18, the shapes of those various portions of the transverse cross-sections affect the aerodynamic properties of the novel aerodynamic grille bar 24. The side portions 40 of a transverse cross-section of a novel aerodynamic grille bar 24 may have any of a number of different types of shapes including concave and convex. A side portion 40 of a transverse cross-section of a novel aerodynamic grille bar 24 that has a convex shape is a side portion 40 that has its radii of curvature disposed upon a same side of that side portion 40 as is the longitudinal axis 18 of the novel aerodynamic grille bar 24. For example, a side portion 40 that has a convex shape is illustrated by the upper of the two side portions 40 of the transverse cross-section of a novel aerodynamic grille bar 24 that is illustrated in FIG. 16. A side portion 40 of a transverse cross-section of a novel aerodynamic grille bar 24 that has a concave shape is a side portion 40 that has its radii of curvature disposed upon an opposite side of that side portion 40 as is the longitudinal axis 18 of the novel aerodynamic grille bar 24. For example, a side portion 40 that has a concave shape is illustrated by the lower of the two side portions 40 of the transverse cross-section of a novel aerodynamic grille bar 24 that is illustrated in FIG. 16. Of course it will be understood that, in some cases such as those shown in FIG. 7, a given side portion 40 of a transverse cross-sections of a novel aerodynamic grille bar 24 will comprise both convex and concave sections. FIG. 16 illustrates a transverse cross-section of a novel aerodynamic grille bars 24 that is in accordance with the present invention and that hasone side portion 40 that has a convex shape and one side portion 40 that has a concave shape. FIGS. 1, 2, 11, 13, 15, 17 illustrate transverse cross-sections of novel aerodynamic grille bars 24 that are in accordance with the present invention and that have side portions 40 that both have a convex shape. Of course it will be understood that there are, nonetheless, embodiments of the present invention that will include novel aerodynamic grille bars 24 and/or other constructions of grille bars 13 that have transverse cross-sections that have side portions 40 with concave shapes.

Another aspect of the shape of a novel aerodynamic grille bar 24 according to the present invention that is an important design consideration is the ratio of the chord length 19 to the maximum width 20 of its transverse cross-sections. Generally, the greater is the ratio of the chord length 19 to the maximum width 20 of a transverse cross-section of a novel aerodynamic grille bar 24 according to the present invention the lesser will be the resistance that transverse cross-section presents to the flow of fluid past it and the shorter will be the stagnation area 17 adjacent the downstream side 15 of that cross-section when fluid flows past it. Thus, it is generally considered that increasing the ratio of the chord length 19 to the maximum width 20 of a transverse cross-section of a novel aerodynamic grille bar 24 will have an advantageous effect upon the aerodynamic properties of that transverse cross-section. It is also true, however, that the lesser is the magnitude of the maximum width 20 of a transverse cross-section of a novel aerodynamic grille bar 24 the lesser is the strength of that transverse cross-section in directions perpendicular to its chord line 41. As a result, in some applications it is advantageous to avoid constructing novel aerodynamic grille bars 24 with transverse cross-sections that have excessively large ratios of their chord length 19 to their maximum width 20 in order to enable the novel aerodynamic grille bars 24 to comply with space constraints while maintaining appropriate levels of strength of the aerodynamic grille bars 24.

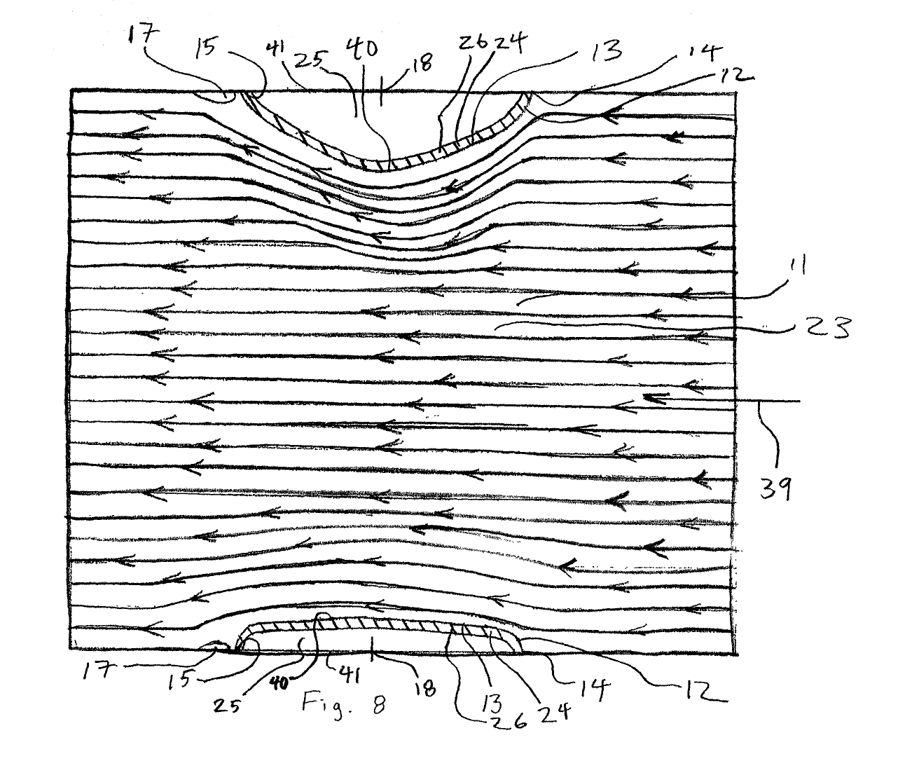

The plurality of novel aerodynamic grille bars 24 of the fluid inlet grille 12 of the present invention may be positioned and oriented in any of a number of ways relative to one another. In the preferred embodiment a plurality of the novel aerodynamic grille bars 24 are oriented and positioned such that their longitudinal axes 18 extend substantially parallel to one another. Adjacent novel aerodynamic grille bars 24 that are positioned in such a manner relative to one another define a fluid flow space 23 between them that, from some point in front of the downstream side 15 of the fluid inlet grille 12, continually widens as it extends toward the downstream side 15 of the fluid inlet grille 12. Such a fluid flow space 23, that has such a shape as a result of being defined between adjacent novel aerodynamic grille bars 24 whose longitudinal axes 18 are disposed parallel to one another, is best illustrated in FIG. 8. As a result of these relationships, two adjacent novel aerodynamic grille bars 24 that are positioned such that their longitudinal axes 18 are parallel to one another act as a nozzle when fluid flows through the fluid flow space 23 defined between them. When fluid flows through the portion of such a fluid flow space 23 that widens as it extends towards the downstream side 15 of the fluid inlet grille 12 there is an advantageous recovery of pressure within the fluid. It will, of course, be understood that a fluid inlet grille 12 according to the present invention may comprise, in addition to a plurality of novel aerodynamic grille bars 24 that are positioned and oriented with their longitudinal axes 18 substantially parallel to one another, one or more grille bars 13, which may or may not comprise one or more novel aerodynamic grille bars 24, that are oriented and positioned in other manners.

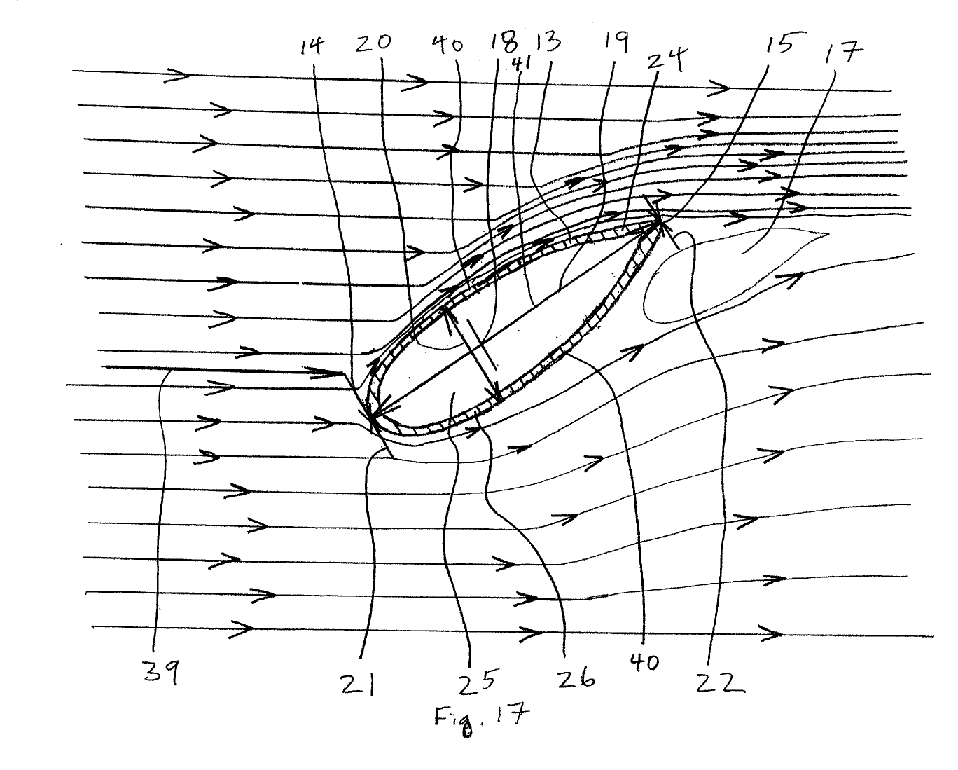

In addition to the orientation of the longitudinal axes 18 of novel aerodynamic grille bars 24 relative to one another, the orientation of each transverse cross-section of the novel aerodynamic grille bars 24 relative to the prevailing fluid inflow direction 39 has a significant effect upon the aerodynamic characteristics of a fluid inlet grille 12 according to the present invention. In particular, the angle between the prevailing fluid inflow direction 39 and the chord line 41 of a transverse cross-section of a novel aerodynamic grille bar 24 has a significant effect upon the flow of fluid past that transverse cross-section of the novel aerodynamic grille bar 24. FIG. 17 illustrates a transverse cross-section of a novel aerodynamic grille bar 24 with that transverse cross-section having its chord line 41 disposed at a relatively large angle to the prevailing fluid inflow direction 39. Each of FIGS. 1, 2, 8, 11, 15, and 16 illustrates a transverse cross-section of a novel aerodynamic grille bar 24 with that transverse cross-section having its chord line 41 disposed at a relatively small angle to the prevailing fluid inflow direction 39. The smaller is the angle between the prevailing fluid inflow direction 39 and the chord-line 41 of a transverse cross-section of a novel aerodynamic grille bar 24, the smaller will be the stagnation area 17 upon the downstream side 15 of the transverse cross-section when fluid flows past it. As a result, it is generally advantageous that a fluid inlet grille 12 according to the present invention be constructed with the novel aerodynamic grille bars 24 thereof oriented in such a manner to minimize the angle between the prevailing fluid inflow direction 39 and the chord lines 41 of transverse cross-sections of its novel aerodynamic grille bars 24.

As was mentioned above, a fluid inlet grille 12 according to the present invention could be utilized in any of a number of different applications. In the preferred embodiment, the fluid inlet grille 12 of the present invention is mounted to a vehicle 10. The vehicle 10 to which the fluid inlet grille 12 is mounted in the preferred embodiment includes one or more frame structure(s) 27. Each of the frame structure(s) 27 of the vehicle 10 is a relatively rigid and strong structure. A large percentage of the components and assemblies of the vehicle 10 are engaged directly to the frame structure(s) 27 of the vehicle 10 and those components of the vehicle 10 that are not engaged directly to the frame structure(s) 27 are engaged indirectly to them. As a result of their relatively rigid and strong construction and the manner in which they are engaged to other components of the vehicle 10 the frame structure(s) 27 of the vehicle 10 function to maintain proper relative locations of most of the components, assemblies, and systems of the vehicle 10. The vehicle 10 to which the fluid inlet grille 12 is mounted in the preferred embodiment also includes a suspension system 28 that is engaged to one or more of the frame structure(s) 27 of the vehicle 10. The suspension system 28 supports the frame structure(s) 27 to which it is engaged above the ground and, thus, supports the other components, assemblies, and systems 10 above the ground. The suspension system 28 is also constructed in such a manner to provide the vehicle 10 with a relatively low resistance to movement along the ground. The vehicle 10, to which the fluid inlet grille 12 is mounted in the preferred embodiment, further comprises one or more body structures 29 that are mounted to one or more of the frame structure(s) 27 of the vehicle 10. In the preferred embodiment, one of the body structure(s) 29 of the vehicle 10 is an operator cabin 30 within which an individual may reside while operating the vehicle 10. The vehicle 10, to which the fluid inlet grille 12 is mounted in the preferred embodiment, also comprises a powertrain 31 for driving the vehicle 10. The powertrain 31 of the vehicle 10 comprises an internal combustion engine 32 and an engine cooling system 33 for maintaining the temperature of the internal combustion engine 32 below levels detrimental to the longevity of the internal combustion engine 32. The engine cooling system 33 comprises a radiator 34 for transferring heat from engine cooling liquid to air in the environment surrounding the vehicle 10. An engine enclosure body structure 35 of the vehicle 10 surrounds to the top and the sides the internal combustion engine 32 and the radiator 34 of the vehicle 10. The engine enclosure body structure 35 could consist of a single component with those portions that surround the internal combustion engine 32 to the top and sides being integrally formed as a single unitary structure. Alternatively, the engine enclosure body structure 35 may comprise multiple components that are attached to one another through various engagement means that may or may not allow the multiple components of the engine enclosure body structure 35 to move relative to one another. The engine enclosure body structure 35 defines, in front of the radiator 34, a fluid flow inlet 11 through which air in front of the vehicle 10 flows when the vehicle 10 travels forward. When the vehicle 10 travels forward in such a manner and air flows through the fluid flow inlet 11 disposed in front of the radiator 34, the air subsequently flows through the radiator 34 and heat is transferred from engine cooling liquid flowing through the tubes of the radiator 34 to the air flowing through the radiator 34. The fluid inlet grille 12 is mounted within the fluid flow inlet 11 defined by the engine enclosure body structure 35 and prevents large objects from traveling through the fluid flow inlet 11 and impacting and damaging the radiator 34 of the vehicle 10. The vehicle 10 also preferably includes a fan 36 disposed upon a side of the radiator 34 opposite the fluid flow inlet 11. When in operation the fan 36 pulls air in through the fluid flow inlet 11 and through the radiator 34 if the vehicle 10 is not moving forward and serves to increase the rate of flow of air through the fluid flow inlet 11 and the radiator 34 if the vehicle 10 is moving forward.

The construction of the fluid inlet grille 12 with novel aerodynamic grille bars 24 as described above provides a number of advantages in the application described above where the fluid inlet grille 12 is mounted in front of a radiator 34 of a vehicle 10. The fluid inlet grille 12 of the present invention, with its novel aerodynamic grille bars 24 presents relatively little resistance to flow of air through the fluid flow inlet 11 in front of the radiator 34 as compared to prior art fluid inlet grilles 38 that have been mounted within fluid flow inlets 11 in front of radiators 34 of vehicles 10. As a result, all other factors being equal, the rate of flow of air through the fluid flow inlet 11 and the radiator 34 that is disposed behind it is greater for a vehicle 10 that has the fluid inlet grille 12 of the present invention mounted within the fluid flow inlet 11 than it is for a vehicle 10 with a prior art fluid inlet grille 38 mounted within the fluid flow inlet 11 in front of the radiator 34. The increased rate of flow of air through the radiator 34 that is effected by implementing the fluid inlet grille 12 of the present invention as compared to prior art fluid inlet grilles 38 results in an increased rate of heat transfer from the engine cooling liquid flowing through the tubes of the radiator 34 and improved performance of the engine cooling system 33. Additionally, all other factors being equal, the stagnation area 17 that is present upon the downstream side 15 of the novel aerodynamic grille bars 24 of the fluid inlet grille 12 of the present invention when air flows through it, is shorter than the stagnation area 17 that is present upon the downstream side 15 of prior art grille bars 37 of prior art fluid inlet grilles 38 when air flows through them. If the radiator 34 of a vehicle 10 is mounted close enough to the downstream side 15 of a fluid inlet grille 12, 38 that it overlaps the stagnation areas 17 adjacent the downstream side 15 of one or more of the grille bars 13 of a fluid inlet grille 12, 38, the performance of the radiator 34 is compromised. In such a situation those portions of the radiator 34 disposed within a stagnation area 17 downstream of a grille bar 13 have air flowing through them at a substantially lower velocity than do portions of the radiator 34 disposed directly downstream of fluid flow spaces 23 defined between the grille bars 13 of the fluid inlet grille 12, 38. By contrast, if a radiator 34 (or other similar heat exchanger) is mounted at a distance from a fluid inlet grille 12, 38 such that the radiator 34 is disposed beyond the stagnation areas 17 upon the downstream side 15 of the grille bars 13 the portions of the radiator 34 that are disposed downstream of the grille bars 13 have fluid flowing through them at substantially the same rate as and transfer heat at substantially the same rate as portions of the radiator 34 that are disposed downstream of the fluid flow spaces 23 that are defined between the grille bars 13 of the fluid inlet grille 12, 38. Thus, the use of a fluid inlet grille 12 constructed according to the present invention allows for mounting of a radiator 34 relatively close to the fluid inlet grille 12 on its downstream side 15 without causing the performance of the engine cooling system 33 to be compromised because the radiator 34 is disposed within the stagnation areas 17 of one or more grille bars 13 of the fluid inlet grille 12. This is beneficial as space for mounting components and systems on vehicles 10 continues to become more and more scarce and cooling demands on engine cooling systems 33 continue to become greater and greater as the power of the internal combustion engines 32 of vehicle power trains 31 continues to rise.

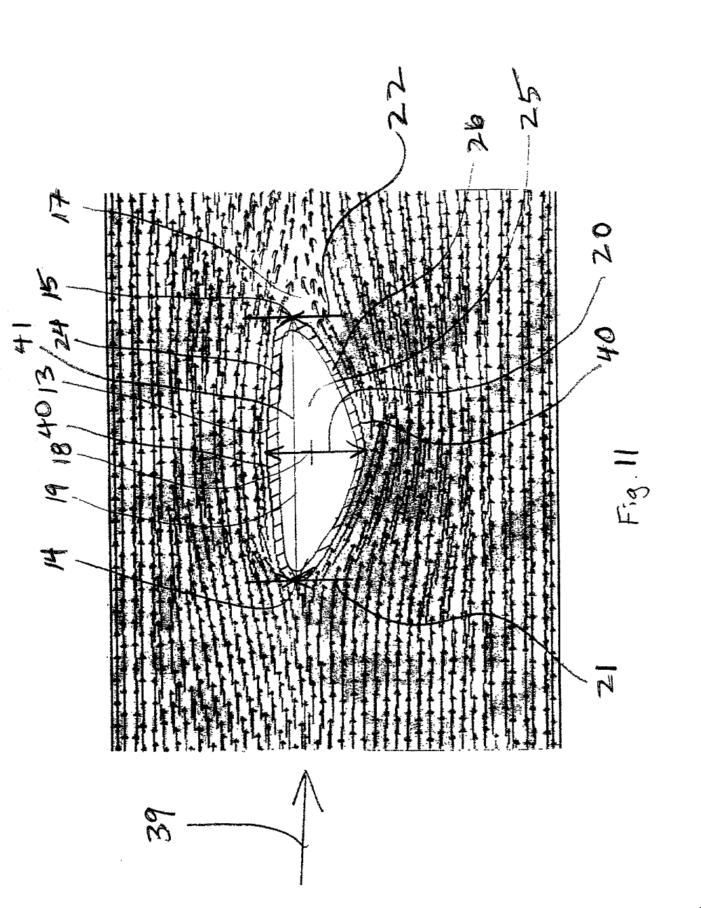

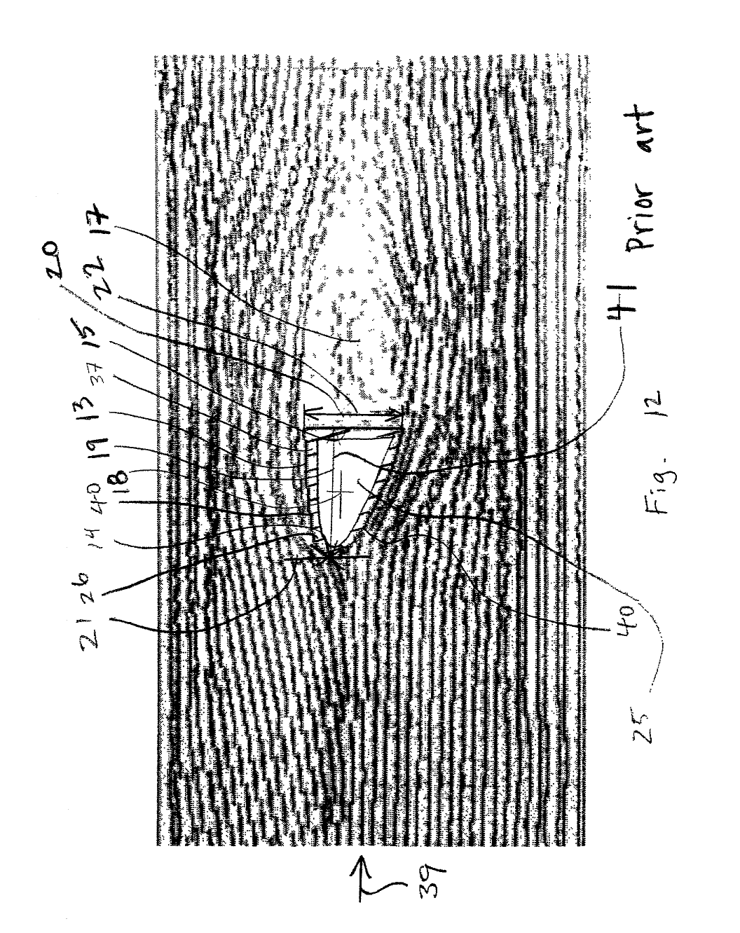

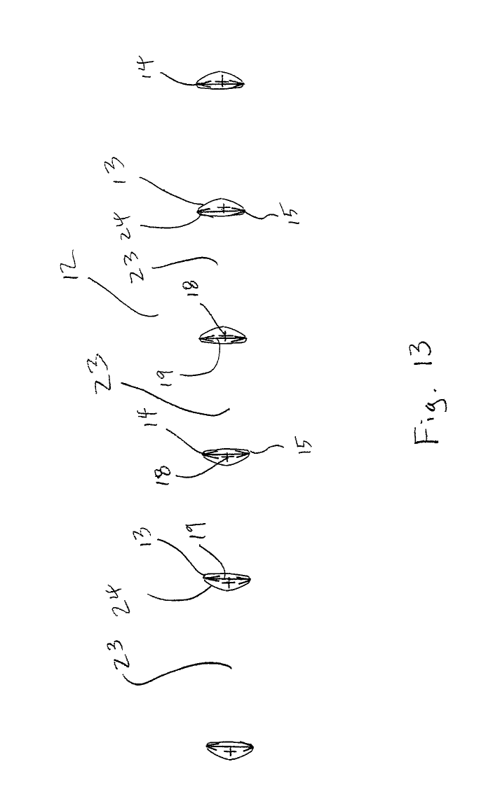

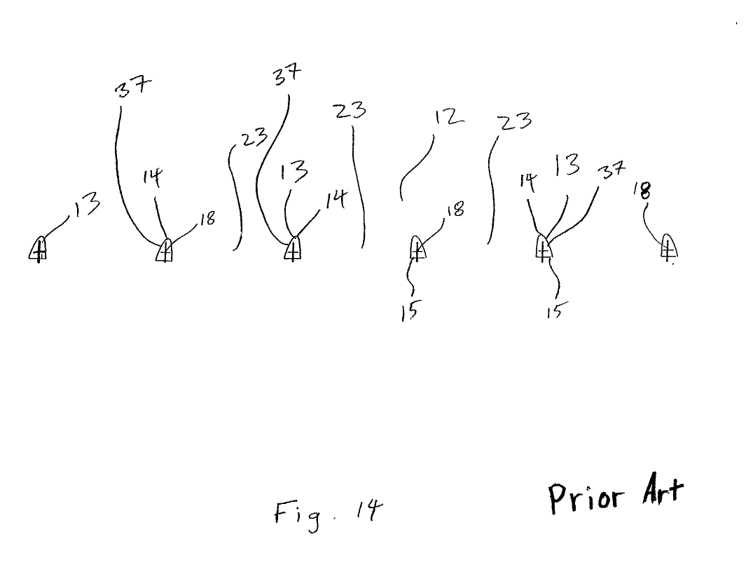

Analysis has shown at least one embodiment of a fluid inlet grille 12 constructed according to the present invention, with novel aerodynamic grille bars 24 that are also constructed according to the present invention, to have substantially better aerodynamic properties than a comparable prior art fluid inlet grille 38. Computational fluid dynamics analysis software has been utilized to analyze the aerodynamic properties of a novel aerodynamic grille bar 24 with the transverse cross-section shown in FIG. 11, which is in accordance with the present invention, and also to analyze the aerodynamic properties of a prior art grille bar 37 that has the transverse cross-section shown in FIG. 12. The computational fluid dynamics analyses that were performed on the grille bars 13 of FIGS. 11 and 12 were each configured to simulate airflow past a grille bar 13 that is part of a fluid inlet grille 12 that comprises additional grille bars 13 that have the same transverse cross-section as the subject grille bar 13. FIG. 13 shows a cross-section of a fluid inlet grille 12 that comprises a plurality of novel aerodynamic grille bars 24 of the transverse cross-section that is in accordance with the present invention and that is shown in FIG. 11. FIG. 14 shows a cross-section of a fluid inlet grille 12 that comprises a plurality of prior art grille bars 37 of the transverse cross-section that is shown in FIG. 12. Two different analyses, of the aerodynamic properties of both the novel aerodynamic grille bar 24 shown in FIG. 11 and the prior art grille bar 37 shown in FIG. 12 were performed. The first analyses of the two grille bars 13 shown in FIGS. 11 and 12 respectively were configured to simulate conditions that would occur when a vehicle 10, to which the fluid inlet grille 12, which comprises the subject grille bar 13, is mounted as described above, travels forward at 15 miles per hour with the fan 36 disposed behind the radiator 34 operating at 1600 RPM. The results of these first analyses show that, at a vehicle speed of 15 miles per hour, the flow rate of air past a fluid inlet grille 12 with novel aerodynamic grille bars 24 of the transverse cross-section shown in FIG. 11 should be 3.5% greater than the flow rate of air past a prior art fluid inlet grille 38 with prior art grille bars 37 of the transverse cross-section shown in FIG. 12. The second analyses of the two grille bars 13 shown in FIGS. 11 and 12 respectively were configured to simulate conditions that would occur when a vehicle 10, to which a fluid inlet grille 12, which comprises the subject grille bar 13, were mounted as described above, travels forward at a rate of 30 miles per hour with the fan 36 behind the radiator 34 operating at 1600 RPM. The results of these second analyses show that, at a vehicle speed of 30 miles per hour, the flow rate of air past the fluid inlet grille 12 with novel aerodynamic grille bars 24 of the transverse cross-section shown in FIG. 11 should be 5% higher than the flow rate of air past the prior art fluid inlet grille 38 with prior art grille bars 37 of the transverse cross-section shown in FIG. 12. The analyses of the aerodynamic properties of the novel aerodynamic grille bar 24 represented in FIG. 11 and the prior art grille bar 37 represented in FIG. 12 were both configured to simulate identical conditions except for the differences between the transverse cross-sections of the respective grille bars 13, and the speed of the vehicle 10. In addition to estimates of rates of fluid flow past grille bars 13 of the transverse cross-sections shown in FIGS. 11 and 12, the above-described computational fluid dynamics analyses were used to produce qualitative information including predicted patterns of airflow around grille bars 13 of the transverse cross-sections shown in FIGS. 11 and 12. FIG. 11 also shows the pattern of airflow that a computational fluid dynamics analysis predicts would occur past the novel aerodynamic grille bar 24 of the transverse cross-section shown in that figure. FIG. 12 also shows the pattern of airflow that a computational fluid dynamics analysis predicts would occur past the prior art grille bar 37 of the cross-section shown in that figure. It is evident by studying FIGS. 11 and 12 that the analyses show a much shorter stagnation area 17 adjacent the downstream side 15 of the novel aerodynamic grille bar 24 shown in FIG. 11 than the stagnation area 17 present upon the downstream side 15 of the prior art grille bar 37 shown in FIG. 12.

It will, of course, be understood that a fluid inlet grille 12 of the present invention and any vehicle 10 that a fluid inlet grille 12 according to the present invention may be mounted to could be of any of a number of different constructions within the guidelines set forth above and that some features of the invention could be employed without a corresponding use of other features.

We claim:

1. A vehicle, comprising:
(a) one or more frame structures to which a large percentage of other components of said vehicle are engaged either directly or indirectly in such a manner that said frame structures function to maintain proper location of said other components of said vehicle relative to one another;
(b) a suspension system that is engaged to said one or more frame structures and which supports said frame structures above the ground and provides said vehicle with a relatively low resistance to movement along the ground;
(c) one or more body structures that are mounted to said frame structures of said vehicle;
(d) one or more components that define a fluid flow inlet through which fluid may flow;
(e) a fluid inlet grille that is mounted to said vehicle and positioned within said fluid flow inlet;
(f) wherein said fluid inlet grille comprises a plurality of grille bars each of which extends along its longitudinal axis across at least some portion of said fluid flow inlet;
(g) wherein one or more of said grille bars of said fluid inlet grille is a novel aerodynamic grille bar that is constructed in such a manner that along a majority of its length its cross-section perpendicular to its longitudinal axis has a chord length that is greater than twice a maximum width of said transverse cross-section, has a maximum width that is greater than a trailing edge width of said transverse cross-section, and has its chord line disposed at an angle of less than ten degrees to a prevailing fluid inflow direction.

2. The vehicle of claim 1, wherein:
(a) one or more of said novel aerodynamic grille bars is constructed in such a manner that along a majority of its length its cross-section perpendicular to its longitudinal axis has a chord length that is greater than three times a maximum width of said transverse cross-section.

3. The vehicle of claim 2, wherein:
(a) one or more of said novel aerodynamic grille bars is constructed in such a manner that along a majority of its length its cross-section perpendicular to its longitudinal axis has a trailing edge width of zero.

4. The vehicle of claim 3, wherein:
(a) a plurality of said novel aerodynamic grille bars are disposed such that their longitudinal axes extend substantially parallel to one another.

5. The vehicle of claim 4, wherein:
(a) one or more of said novel aerodynamic grille bars is constructed in such a manner that along a majority of its length both side portions of its cross-section perpendicular to its longitudinal axis have a convex shape.

6. The vehicle of claim 5, wherein:
(a) one or more of said novel aerodynamic grille bars is constructed in such a manner that along a majority of its length its cross-section perpendicular to its longitudinal axis has a leading edge width of zero.

7. The vehicle of claim 6, wherein:
(a) said one or more components that define said fluid flow inlet, within which said fluid inlet grille is disposed, comprise an engine enclosure body structure.

8. The vehicle of claim 7, wherein:
(a) one or more heat exchangers is mounted to said vehicle adjacent to said fluid flow inlet and upon a downstream side of said fluid inlet grille mounted within said fluid flow inlet.

9. The vehicle of claim 1, wherein:
(a) said one or more components that define said fluid flow inlet, within which said fluid inlet grille is disposed, comprise an engine enclosure body structure.

10. The vehicle of claim 9, wherein:
(a) one or more heat exchangers is mounted to said vehicle adjacent to said fluid flow inlet and upon a downstream side of said fluid inlet grille mounted within said fluid flow inlet.

11. The vehicle of claim 10, wherein:
(a) one or more of said novel aerodynamic grille bars is constructed in such a manner that along a majority of its length its cross-section perpendicular to its longitudinal axis has a trailing edge width of zero.

12. The vehicle of claim 11, wherein:
(a) one or more of said novel aerodynamic grille bars is constructed in such a manner that along a majority of its length its cross-section perpendicular to its longitudinal axis has a chord length that is greater than three times a maximum width of said transverse cross-section.

13. The vehicle of claim 1, wherein:
(a) one or more of said novel aerodynamic grille bars is constructed in such a manner that along a majority of its length its cross-section perpendicular to its longitudinal axis has a trailing edge width of zero.

14. The vehicle of claim 1, wherein:
(a) one or more of said novel aerodynamic grille bars is constructed in such a manner that along a majority of its length both side portions of its cross-section perpendicular to its longitudinal axis have a convex shape.

15. The vehicle of claim 14, wherein:
(a) a plurality of said novel aerodynamic grille bars that are constructed in such a manner that along a majority of their length both side portions of their cross-sections perpendicular to their longitudinal axis have a convex shape are disposed such that their longitudinal axes extend substantially parallel to one another.

16. The vehicle of claim 10, wherein:
(a) one or more of said novel aerodynamic grille bars is constructed in such a manner that along a majority of its length both side portions of its cross-section perpendicular to its longitudinal axis have a convex shape.

17. The vehicle of claim 16, wherein:
(a) a plurality of said novel aerodynamic grille bars that are constructed in such a manner that along a majority of their length both side portions of their cross-sections perpendicular to their longitudinal axis have a convex shape are disposed such that their longitudinal axes extend substantially parallel to one another.

18. The vehicle of claim 10, wherein:
(a) one or more of said novel aerodynamic grille bars is constructed in such a manner that along a majority of its length its cross-section perpendicular to its longitudinal axis has a chord length that is greater than three times a maximum width of said transverse cross-section.

19. The vehicle of claim 1, wherein:
(a) one or more of said novel aerodynamic grille bars is constructed in such a manner that along a majority of its length its cross-section perpendicular to its longitudinal axis has a maximum width that is greater than two times a trailing edge width of said transverse cross-section.

20. The vehicle of claim 1, wherein:
(a) one or more of said novel aerodynamic grille bars is constructed in such a manner that along a majority of its length its cross-section perpendicular to its longitudinal axis has an outer wall that completely surrounds an inner void.

21. The vehicle of claim 2, wherein:
(a) one or more of said novel aerodynamic grille bars is constructed in such a manner that along a majority of its length its cross-section perpendicular to its longitudinal axis has an outer wall that completely surrounds an inner void.

22. The vehicle of claim 3, wherein:
(a) one or more of said novel aerodynamic grille bars is constructed in such a manner that along a majority of its length its cross-section perpendicular to its longitudinal axis has an outer wall that completely surrounds an inner void.

23. The vehicle of claim 10, wherein:
(a) one or more of said novel aerodynamic grille bars is constructed in such a manner that along a majority of its length its cross-section perpendicular to its longitudinal axis has an outer wall that completely surrounds an inner void.

24. The vehicle of claim 1, wherein:
(a) one or more of said novel aerodynamic grille bars is constructed in such a manner that along a majority of its length its cross-section perpendicular to its longitudinal axis has a chord length that is less than five times a maximum width of said transverse cross-section.

25. The vehicle of claim 2, wherein:
(a) one or more of said novel aerodynamic grille bars is constructed in such a manner that along a majority of its length its cross-section perpendicular to its longitudinal axis has a chord length that is less than five times a maximum width of said transverse cross-section.

26. The vehicle of claim 3, wherein:
(a) one or more of said novel aerodynamic grille bars is constructed in such a manner that along a majority of its length its cross-section perpendicular to its longitudinal axis has a chord length that is less than five times a maximum width of said transverse cross-section.

27. The vehicle of claim 10, wherein:
(a) one or more of said novel aerodynamic grille bars is constructed in such a manner that along a majority of its length its cross-section perpendicular to its longitudinal axis has a chord length that is less than five times a maximum width of said transverse cross-section.

28. The vehicle of claim 1, wherein:
(a) one or more of said novel aerodynamic grille bars is constructed in such a manner that along a majority of its length its cross-section perpendicular to its longitudinal axis has a chord length that is less than three times a distance between a trailing edge of said transverse cross-section and a portion of said transverse cross-section at which its maximum width occurs.

29. The vehicle of claim 2, wherein:
(a) one or more of said novel aerodynamic grille bars is constructed in such a manner that along a majority of its length its cross-section perpendicular to its longitudinal axis has a chord length that is less than three times a distance between a trailing edge of said transverse cross-section and a portion of said transverse cross-section at which its maximum width occurs.

30. The vehicle of claim 3, wherein:
(a) one or more of said novel aerodynamic grille bars is constructed in such a manner that along a majority of its length its cross-section perpendicular to its longitudinal axis has a chord length that is less than three times a distance between a trailing edge of said transverse cross-section and a portion of said transverse cross-section at which its maximum width occurs.

31. The vehicle of claim 10, wherein:
(a) one or more of said novel aerodynamic grille bars is constructed in such a manner that along a majority of its length its cross-section perpendicular to its longitudinal axis has a chord length that is less than three times a distance between a trailing edge of said transverse cross-section and a portion of said transverse cross-section at which its maximum width occurs.

32. A vehicle, comprising:
(a) one or more frame structures to which a large percentage of other components of said vehicle are engaged either directly or indirectly in such a manner that said frame structures function to maintain proper location of said other components of said vehicle relative to one another;
(b) a suspension system that is engaged to said one or more frame structures and which supports said frame structures above the ground and provides said vehicle with a relatively low resistance to movement along the ground;
(c) one or more body structures that are mounted to said one or more frame structures of said vehicle;
(d) one or more components that define a fluid flow inlet through which fluid may flow;
(e) a fluid inlet grille that is mounted to said vehicle within said fluid flow inlet;
(f) wherein said fluid inlet grille comprises a plurality of grille bars each of which extends along its longitudinal axis across at least some portion of said fluid flow inlet;
(g) wherein one or more of said grille bars of said fluid inlet grille are novel aerodynamic grille bars; and
(h) wherein one or more of said aerodynamic grille bars is a novel aerodynamic grille bar that is constructed in such a manner that along a majority of its length its cross-section perpendicular to its longitudinal axis has a chord length that is greater than twice a maximum width of said transverse cross-section and less than five times a maximum width of said transverse cross-section, and has a maximum width that is greater than a trailing edge width of said transverse cross-section.

33. The vehicle of claim 32, wherein:
(a) one or more of said novel aerodynamic grille bars is constructed in such a manner that along a majority of its length its cross-section perpendicular to its longitudinal axis has a chord length that is greater than three times a maximum width of said transverse cross-section.

34. The vehicle of claim 33, wherein:
(a) one or more of said novel aerodynamic grille bars is constructed in such a manner that along a majority of its length its cross-section perpendicular to its longitudinal axis has a trailing edge width of zero.

35. The vehicle of claim 34, wherein:
(a) one or more of said novel aerodynamic grille bars is constructed in such a manner that along a majority of its length both side portions of its cross-section perpendicular to its longitudinal axis have a convex shape.

36. The vehicle of claim 35, wherein:
(a) said one or more components that define said fluid flow inlet, within which said fluid inlet grille is disposed, comprise an engine enclosure body structure.

37. The vehicle of claim 36, wherein:
(a) one or more heat exchangers is mounted to said vehicle adjacent to said fluid flow inlet and upon a downstream side of said fluid inlet grille mounted within said fluid flow inlet.

38. The vehicle of claim 32, wherein:
(a) said one or more components that define said fluid flow inlet, within which said fluid inlet grille is disposed, comprise an engine enclosure body structure.

39. The vehicle of claim 38, wherein:
(a) one or more heat exchangers is mounted to said vehicle adjacent to said fluid flow inlet and upon a downstream side of said fluid inlet grille mounted within said fluid flow inlet.

40. The vehicle of claim 39, wherein:
(a) one or more of said novel aerodynamic grille bars is constructed in such a manner that along a majority of its length its cross-section perpendicular to its longitudinal axis has a trailing edge width of zero.

41. The vehicle of claim 40, wherein:
(a) one or more of said novel aerodynamic grille bars is constructed in such a manner that along a majority of its length its cross-section perpendicular to its longitudinal axis has a chord length that is greater than three times a maximum width of said transverse cross-section.

42. The vehicle of claim 32, wherein:
(a) one or more of said novel aerodynamic grille bars is constructed in such a manner that along a majority of its length its cross-section perpendicular to its longitudinal axis has a trailing edge width of zero.

43. The vehicle of claim 32, wherein:
(a) one or more of said novel aerodynamic grille bars is constructed in such a manner that along a majority of its length side portions of its cross-section perpendicular to its longitudinal axis have a convex shape.

44. The vehicle of claim 43, wherein:
(a) a plurality of said novel aerodynamic grille bars that are constructed in such a manner that along a majority of their length both side portions of their cross-sections perpendicular to their longitudinal axis have a convex shape are disposed such that their longitudinal axes extend substantially parallel to one another.

45. The vehicle of claim 36, wherein:
(a) one or more of said novel aerodynamic grille bars is constructed in such a manner that along a majority of its length both side portions of its cross-section perpendicular to its longitudinal axis have a convex shape.

46. The vehicle of claim 45, wherein:
(a) a plurality of said novel aerodynamic grille bars that are constructed in such a manner that along a majority of their length both side portions of their cross-sections perpendicular to their longitudinal axis have a convex shape are disposed such that their longitudinal axes extend substantially parallel to one another.

47. The vehicle of claim 32, wherein:
(a) one or more of said novel aerodynamic grille bars is constructed in such a manner that along a majority of its length its cross-section perpendicular to its longitudinal axis has a maximum width that is greater than two times a trailing edge width of said transverse cross-section.

48. The vehicle of claim 32, wherein:
(a) one or more of said novel aerodynamic grille bars is constructed in such a manner that along a majority of its length its cross-section perpendicular to its longitudinal axis has an outer wall that completely surrounds an inner void.

49. The vehicle of claim 33, wherein:
(a) one or more of said novel aerodynamic grille bars is constructed in such a manner that along a majority of its length its cross-section perpendicular to its longitudinal axis has an outer wall that completely surrounds an inner void.

50. The vehicle of claim 34, wherein:
(a) one or more of said novel aerodynamic grille bars is constructed in such a manner that along a majority of its length its cross-section perpendicular to its longitudinal axis has an outer wall that completely surrounds an inner void.

51. The vehicle of claim 37, wherein:
(a) one or more of said novel aerodynamic grille bars is constructed in such a manner that along a majority of its length its cross-section perpendicular to its longitudinal axis has an outer wall that completely surrounds an inner void.

52. The vehicle of claim 32, wherein:
(a) one or more of said novel aerodynamic grille bars is constructed in such a manner that along a majority of its length its cross-section perpendicular to its longitudinal axis has a chord length that is less than three times a distance between a trailing edge of said transverse cross-section and a portion of said transverse cross-section at which its maximum width occurs.

53. The vehicle of claim 33, wherein:
(a) one or more of said novel aerodynamic grille bars is constructed in such a manner that along a majority of its length its cross-section perpendicular to its longitudinal axis has a chord length that is less than three times a distance between a trailing edge of said transverse cross-section and a portion of said transverse cross-section at which its maximum width occurs.

54. The vehicle of claim 34, wherein:
(a) one or more of said novel aerodynamic grille bars is constructed in such a manner that along a majority of its length its cross-section perpendicular to its longitudinal axis has a chord length that is less than three times a distance between a trailing edge of said transverse cross-section and a portion of said transverse cross-section at which its maximum width occurs.

55. The vehicle of claim 37, wherein:
(a) one or more of said novel aerodynamic grille bars is constructed in such a manner that along a majority of its length its cross-section perpendicular to its longitudinal axis has a chord length that is less than three times a distance between a trailing edge of said transverse cross-section and a portion of said transverse cross-section at which its maximum width occurs.
